(19) United States
(12) Patent Application Publication
(10) Pub. No.: US 2009/0222818 A1
(43) Pub. Date: Sep. 3, 2009

(54) FAST WORKFLOW COMPLETION IN A MULTI-SYSTEM LANDSCAPE

(75) Inventor: Marco Valentin, Malsch (DE)

Correspondence Address: BRAKE HUGHES BELLERMANN LLP, C/O CPA Global, P.O. BOX 52050, MINNEAPOLIS, MN, 55402, US

(73) Assignee: SAP AG, Walldorf (DE)

(21) Appl. No.: 12/040,708

(22) Filed: Feb. 29, 2008

(51) Int. Cl. G06F 9/46

(52) U.S. Cl. 718/100

(57) ABSTRACT

A method of performing a business reporting job process may include starting, on a central system, a distributed job process, including a plurality of jobs. The method may also include initiating one of the plurality of jobs to be performed by at least one assigned satellite system. Such initiating may include transmitting a central system job context, associated with the initiated job by the central system, from the central system to the satellite system. The method may further include processing the job on the assigned satellite system utilizing the central system job context. And, upon a completion of the job by the satellite system, reporting the completion of the job to the central system, and transmitting at least one result of the job from the satellite system to the central system. The method may further include checking whether or not the result of the job is acceptable, based upon a set of predetermined criteria.

### TECHNICAL FIELD

This description relates to the coordination of a workflow across multiple systems, and more specifically to the automated coordination of workflow using multiple systems.

### BACKGROUND

Customer relationship management (CRM) is typically the practice of intelligently finding, marketing to, selling to, and servicing customers. Frequently, CRM includes the capture, storage, and analysis of information relating to customers, vendors, partners, and/or internal systems. Often a user may wish to combine or synthesize information from multiple systems.

Often synthesizing information from multiple systems, in the context of CRM applications or in other settings, includes performing or executing multiple jobs on a distributed network of computing systems. The plurality of jobs may be arranged in a workflow that dictates, for example, the order and precedence of the jobs.

### SUMMARY

According to one general aspect, a method of performing a business reporting job process may include starting, on a central system, a distributed job process, including a plurality of jobs. The method may also include initiating one of the plurality of jobs to be performed by at least one assigned satellite system. Such initiating may include transmitting a central system job context, associated with the initiated job by the central system, from the central system to the satellite system. The method may further include processing the job on the assigned satellite system utilizing the central system job context. And, upon a completion of the job by the satellite system, reporting the completion of the job to the central system, and transmitting at least one result of the job from the satellite system to the central system. The method may further include checking whether or not the result of the job is acceptable, based upon a set of predetermined criteria.

According to another general aspect, a system may include a central computing system that includes a central data storage configured to store data associated with a job. Access to the data may be facilitated by a central job context associated with the job. The central computing system may include a schedule manager configured to manage a distributed job process including a plurality of jobs, initiate one of the plurality of jobs to be performed by at least one satellite computing system, including transmitting the central job context from the central system to the satellite system. The system may also include a plurality of satellite computing systems. Each satellite computing system may include a satellite data storage configured to store data, wherein access the data may be facilitated by a satellite job context associated with the job. Each satellite computing system may also include a satellite job processor configured to process a job initiated by the central computing system, report the completion of the job to the central computing system, and transmit at least one result of the job from the satellite computing system to the central computing system for checking.

According to another general aspect, a machine readable medium may include instructions capable of being executed by at least one machine, which, when executed, cause the machine to start, on a central system, a distributed job process, including a plurality of jobs, assign one of the plurality of jobs to a satellite system, initiate the job to be performed by the assigned satellite system, including transmitting a central system job context, associated with the initiated job by the central system, from the central system to the satellite system, processing the job by the assigned satellite system utilizing the central system job context, and, upon a completion of the job by the satellite system, report the completion of the job to the central system, and transmit at least one result of the job from the satellite system to the central system, and check whether or not the result of the job is acceptable based upon a set of predetermined criteria

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an embodiment of a system in accordance with the disclosed subject matter.

FIG. 2 is a block diagram of an embodiment of a system in accordance with the disclosed subject matter.

FIG. 3 is a block diagram of an embodiment of two systems in accordance with the disclosed subject matter.

FIG. 4 is a flow chart of an embodiment of a workflow in accordance with the disclosed subject matter.

FIG. 5 is a flow chart of an embodiment of a technique in accordance with the disclosed subject matter.

### DETAILED DESCRIPTION

Often, controlling or managing distributed computing processes or workflows is difficult. Typically, the distributed systems used to complete the plurality of jobs in the workflow are not designed to work together and are managed by a third party system or by human interaction.

For example, the act of starting each job may include a user manually starting the job. Likewise, when the job is complete a user may need to communicate with another person that the job is complete and that a subsequent job may be started. These inter-personal interactions frequently delay the completion of the plurality of jobs.

In another example, completion of the plurality of jobs may be managed by a third party system. Typically, a third party system is added to a distributed computing system as an after thought. The third party system, frequently, coordinates computing systems that are not designed to work together. While the third party system may automatically start each of the plurality of jobs, it typically does not perform any error checking of the results of the jobs. Therefore, the plurality of jobs may complete with incorrect results due to the failure of a job relatively early in the process. Such an error may not be discovered until time has been expended completing the entire plurality of jobs.

A system for the automated coordination of a workflow using a multiple systems is described below. In various embodiments, the system may perform automatic job initiation and results checking.

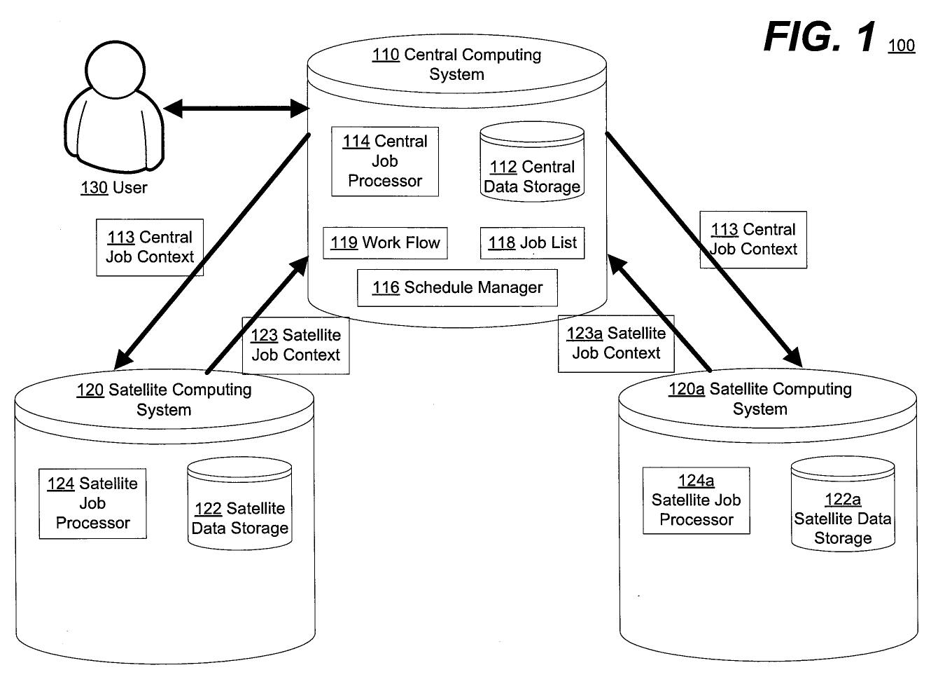

Referring to the Figures in which like numerals indicate like elements, FIG. 1 is a block diagram of an embodiment of a system 100 in accordance with the disclosed subject matter. In one embodiment, the system 100 may include a central computing system 110 and a plurality of satellite computing systems 120 and 120a. In various embodiments, the central computing system 110 may include a central data storage 112 and a schedule manager 116. In some embodiments, the satellite computing systems 120 and 120a may include a satellite job processor 124 and 124a and a satellite data storage 122 and 122a.

In one embodiment, the schedule manager 116 may be configured to manage a distributed job process including a plurality of jobs. In various embodiments, the plurality of jobs may be organized into a job list 118. In various embodiments, the distributed job process may include a business reporting job process, such as, for example, financial reporting, accounting reporting, customer relationship reporting, etc.. In one illustrative embodiment that will be used throughout to provide a non-limiting context for the disclosed subject matter, the plurality of jobs may pertain to the quarterly or yearly financial reporting requirements experienced by many businesses. These financial reporting requirements may be referred to as the “period end closing”. The plurality of jobs of the job list 118 may be the period end closing process undertaken by the business. In this embodiment, a specific computing system may be designated the central computing system 110 and manage the job list 118.

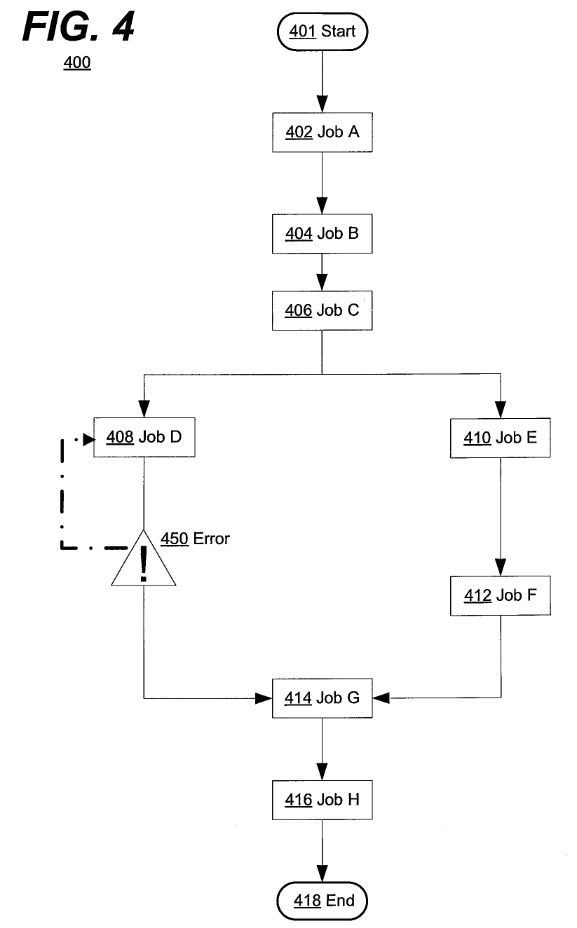

In one embodiment, a user 130 may initiate a distributed job process from a central computing system 110. In various embodiments, the schedule manager 116 may be configured to organize a job list 118, which includes a plurality of jobs, into a workflow 119. In some embodiments, the workflow 119 may indicate relationship characteristics between the jobs. Some characteristics may include, in one embodiment, which jobs may be performed in serial, which jobs, may be performed in parallel, the dependencies between the jobs, the order in which the jobs may or are to be performed, etc.; although, it is understood that the above are merely a few illustrative examples to which the disclosed subject matter is not limited. As described below, FIG. 4 may further illustrate an embodiment of a workflow 119.

To continue the above illustrative non-limiting embodiment dealing with financial reporting, the job list 118 may include the period end closing process undertaken by the business. The job list 118 may indicate that financial reports are needed from each separate business unit. Also, the business units may be arranged in a hierarchal fashion, forming business divisions, subsidiaries, etc.. In some embodiments, the business units may span multiple countries or jurisdictions. The schedule manager 116 may be configured to arrange these various jobs into a workflow 119. For example, the workflow 119 may dictate that lower tiers of the hierarchy may need to be completed before being “rolled up” to compute the financial reporting of the higher tiers of the hierarchy of business units. Other dependencies, parallelisms, etc. may be represented in the workflow 119 of this illustrative non-limiting embodiment.

In one embodiment, the schedule manager 116 may be configured to assign a one of the plurality of jobs 118 to either the central computing system 110 or one of the satellite systems 120 or 120a. In one embodiment, the schedule manager 116 may be configured to initiate the processing of the assigned job to be performed by the assigned satellite computing system 120. In particular embodiments, the satellite computing system 120 may include a satellite job processor 124 configured to process the job initiated by the central computing system 110. The satellite job processor 124 may also be configured to report the completion of the job to the central computing system 110, and transmit at least one result of the job from the satellite computing system 124 to the central computing system 110 for checking. In one embodiment, the satellite system 120 or the satellite job processor 124 may be configured to automatically report the completion of the assigned job to the central computing system 110, without the need for manual human action.

To continue the above illustrative non-limiting embodiment dealing with financial reporting, the schedule manager 116 may determine that the financial results from the Japanese subsidiary or business unit are required. The schedule manager 116 may initiate the compilation of the financial results on a satellite computing system 120 located in Japan. The satellite computing system 124 may receive the request and proceed to process or perform the job. Once the job has been completed, the results may be transmitted back to the central computing system 110. The completion of the assigned job may be automatically reported such that human reporting is not required. This may be contrasted with existing job management systems in which the completion of a job is typically reported by one human to another, for example, via phone call, email, or other form of communication. Such a system may be cumbersome especially when the communication involves different time zones. Substantially simultaneously, the schedule manager 116 may initiate jobs at the same or different satellite computing systems (e.g., satellite computing system 120a). For example, a financial report may be needed from the Texas or German business unit.

In one embodiment, a central job context 113 may be transmitted from the central computing system 110 to the satellite system 120. In various embodiments, a job context (e.g., central job context 113) may include an identifier or handle that allows data and information about a particular job to be accessed and/or stored. For example, in one embodiment, the central job context 113 may allow the satellite computing system 120 to indicate to the central computing system 110 that returned information pertains to the particular job. In another embodiment, the central job context 113 may allow the satellite computing system 120 to access data that pertains to the assigned job and is stored in the central data storage 112 on the central computing system 110.

In one embodiment, the satellite computing system 120 may include a satellite data storage 122 configured to store data. The stored data may include data pertinent to the job processed by the satellite job processor 124. In various embodiments, the stored data may be associated with a satellite job context 123. This satellite job context 123 may, in one embodiment, be communicated to the central computing system 110 or another satellite computing system 120a, in order for the systems to better access information stored on the satellite computing system 120 and related to the assigned job. It is understood that each assigned job may have a different job context both in terms of the central job context 113 and the satellite job context 123.

In some embodiments, the satellite job processor 124 may use the central job context 113 to access the central data storage 112. For example, the satellite job processor 124 may be configured to return the results of the job using the central data storage 112. In another embodiment, the satellite job processor 124 may be configured to retrieve information from the central data storage 112 in order to complete the assigned job. Or, in yet another embodiment, the satellite job processor 124 may be configured to store intermediate or final results in the central data storage 112.

Likewise, in one embodiment, the schedule manager 116 may be configured to use the satellite job context 123 to access the satellite data storage 122. In some embodiments, the schedule manager 116 may be configured to use the data or a portion thereof stored within the satellite data storage 122 to manage the decentralized job process. In one embodiment, the satellite job processor 124 may not directly transmit all the results of a job back to the central computing system 110. Instead, the satellite job processor 124 may be configured to report the completion of the job and the satellite job context 123 to the central computing system 110. The central computing system 110 may then access the satellite data storage 122 using the satellite job context 123 in order to retrieve the results.

In one embodiment, the central computing system 110 and the satellite computing system 120 may make use of a bi-directional Remote Procedure Call (RPC, a.k.a., remote function call or remote method invocation) to communicate information, both technical information and business information, associated with the assigned job between the two systems. In this context, a RPC may include a technology that allows a computer program to cause a subroutine or procedure to execute on another computing system (e.g., satellite computing system 120 or central computing system 110) without the programmer explicitly coding the details for this remote interaction. In this context, the technical information may include the information (often control information, in one embodiment) used to initiate and dictate how the assigned job is to be performed. Whereas, the business information, in this context, may be the raw data used to perform the assigned job (e.g., sales and customer data) and the results (intermediate or final) of the assigned job. In various embodiments, the bi-directional RPC may include multiple unidirectional RPCs that when combined function as a bi-directional RPC.

In one embodiment, the central computing system may also include a central job processor 114 and a central data storage 112. In various embodiments, the schedule manager 116 may be further configured to initiate a job, from the job list 118, on the central computing system 110. In such an embodiment, a portion of the job list 118 or workflow 119 may be performed on various computing systems (e.g., central computing system 110, or satellite computing systems 120 and 120a) as the schedule manager 116 deems fit (e.g., more expedient, efficient, convenient, etc.).

In one embodiment, once the results of the assigned job are reported (or retrieved by) the schedule manager 116, the schedule manager 116 may automatically check whether or not the results of the assigned job are acceptable. In various embodiments, the schedule manager 116 may automatically check whether or not the results of the assigned job are acceptable without any need for manual human checking. In some embodiments, the acceptability may be based upon various criteria that are predetermined. Such manual configuring of the predetermined criteria for acceptability does not mean that the checking involves manual human checking. Various criteria may include, but are not limited to, criteria based upon substantive or business information (such as, confirming that the results are within a given range, confirming that the results generally confirm to a given trend, etc.) or criteria based upon a procedural information (such as, having properly formatted data in all fields of the result, successful competition of all tasks associated with the process, completion of the job within a given timeframe, etc.); although, it is understood that the above are merely a few illustrative examples to which the disclosed subject matter is not limited.

To continue the above illustrative non-limiting embodiment dealing with financial reporting, the schedule manager 116 may determine if the financial results from the Japanese subsidiary or business unit are acceptable. In various embodiments, the schedule manager 116 may confirm that all fields of the financial results contain properly formatted data, that the data in each field has been recently computed, that the data is within an acceptable range based upon previous results from prior quarters and years, and that the data is within an acceptable range of any prior predictions made about the financial results for the period being closed; although, it is understood that the above are merely a few illustrative examples to which the disclosed subject matter is not limited. If any of these acceptability criteria are not met the schedule manager 116 may take corrective action. In various embodiments, the corrective action may result in flagging the error to a user 130 or rerunning the job. In one embodiment, the acceptability of the results may be automatically computed without a need for manual human checking. This is contrasted with existing job management systems, in which the result of the jobs are generally either not checked at all or checked by hand by a user 130.

As mentioned above, in one embodiment, the returned results may be deemed unacceptable. In such an embodiment, a variety of actions may be taken to ameliorate the situation. Such actions may include, but are not limited to, informing a user 130 of the failure of the results of the job, marking the job as a failed job, continuing to process other jobs from the plurality of jobs 118 that are not dependent upon the results of the failed job, restarting the failed job, etc.; although, it is understood that the above are merely a few illustrative examples to which the disclosed subject matter is not limited.

In various embodiments, the schedule manager 116 may be configured to continue initiating jobs on either the central computing system 110 or the plurality of satellite computing systems 120 and 120a until the workflow 119 is completed or, alternatively, some other event occurs (e.g., the workflow 119 may be blocked due to a dependency upon a failed prior job, or termination of the process by a user 130). Upon the completion of the workflow 119 the final result(s) may, in one embodiment, be reported to the user 130.

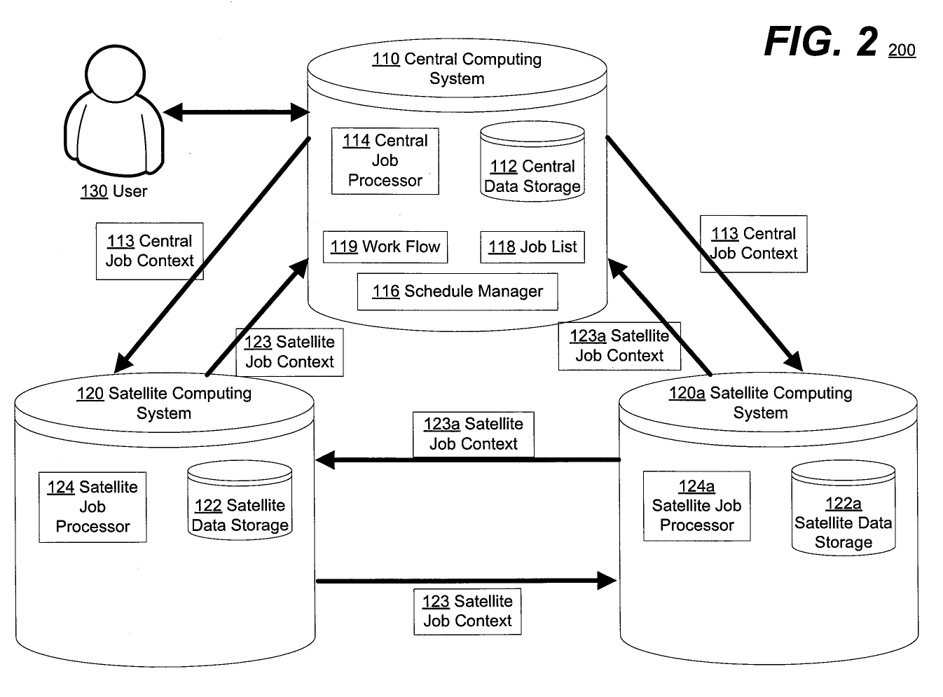

FIG. 2 is a block diagram of an embodiment of a system 200 in accordance with the disclosed subject matter. In this embodiment, the central computing system 110 may be configured to initiate or assign a job from the job list 118 or workflow 119 to both the satellite computing system 120 and the satellite computing system 120a. In the case of the satellite computing system 120 the central job context 113 and the satellite job context 123 may be exchanged. In the case of the satellite computing system 120a the central job context 113 and the satellite job context 123a may be exchanged.

In such an embodiment, the satellite job processor 124 may be configured to also transmit the satellite job context 123 to the second satellite computing system 120a. The second satellite job processor 124a may then make use of the satellite job context 123 to perform the job assigned to the second satellite computing system 120a. Likewise, the second satellite computing system 120a may transmit the second satellite job context 123a to the first satellite computing system 120. Using the respective job contexts, data stored on the respective computing systems may be accessed.

To continue the above illustrative non-limiting embodiment dealing with financial reporting, the schedule manager 116 may assign a job to the second satellite computing system 120a, the results of which may be needed by the job assigned to the first satellite computing system 120. For example, the first satellite computing system 120 may be assigned the job of processing the financial reports for the electronics division of the company. The second satellite computing system 120a may be assigned the job of processing the financial reports of the home electronics sub-division of electronics division the company. In such an instance, the schedule manager 116 may instruct the two satellite computing systems 120 and 120a to interact with each other when performing the jobs. In order to facilitate this interaction, the satellite computing systems may exchange the job contexts 123 and 123a, and share their respective satellite data storage components 122 and 122a.

In a different embodiment of the above illustrative non-limiting embodiment dealing with financial reporting, the schedule manager 116 may receive and check the results of the sub-division financial reports from the second satellite computing system 120a before instructing the two satellite computing systems 120 and 120a to interact. In yet another embodiment, the schedule manager 116 may act as a intermediary or “middle-man”, providing the second satellite job context 123a to the first satellite computing system 120, and vice versa, as opposed to direct interaction initially or, in one embodiment, ever between the two satellite computing systems 120 and 120a.

In one embodiment, the first satellite computing system 120 (assigned the job of the financial reports for the electronics division) may be configured to automatically receive and check the results of the job assigned to the second satellite computing system 120a (assigned the financial reports of the sub-division of the electronics division), as described above in relation to the central computing system 110. Furthermore, in various embodiments, the two satellite computing systems 120 and 120a may communicate via bi-directional RPCs.

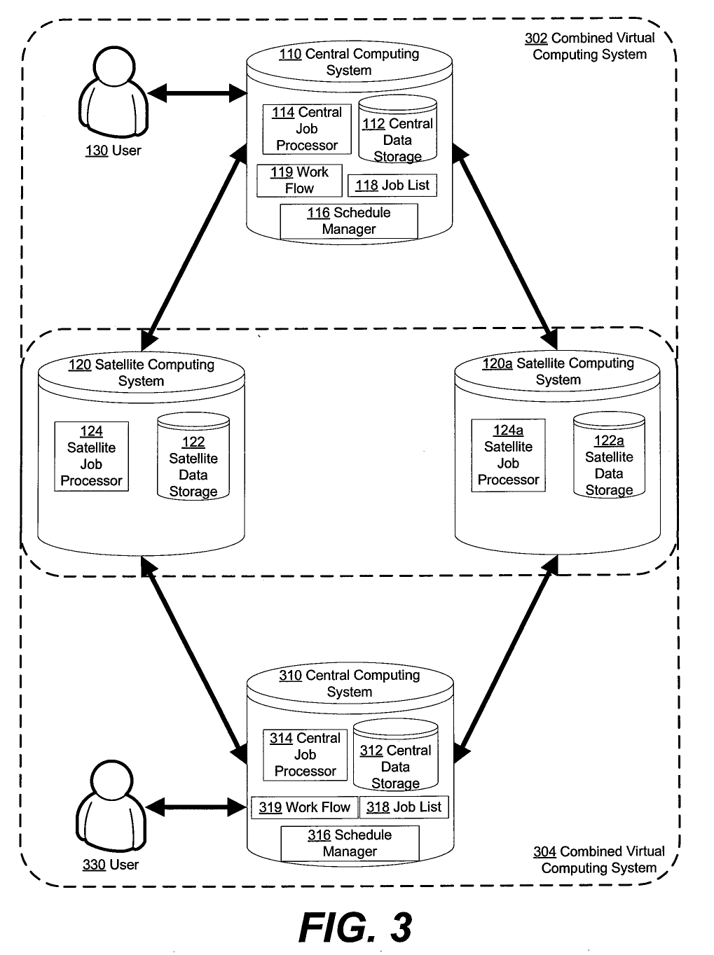

FIG. 3 is a block diagram of an embodiment of two systems 302 and 304 in accordance with the disclosed subject matter. In one embodiment, the central computing system and the plurality of satellite computing systems may act as a combined virtual system. In one embodiment, the combined virtual computing system 302 may include the central computing system 110 and the plurality of satellite computing systems 120 and 120a. As such, the combined virtual computing system 302 may be configured to operate as a virtual system. A user 130 may interact with the virtual system 302 as if it was a monolithic computing system as opposed to three computing systems. In various embodiments, the computing systems 110, 120, and 120a may interact with each other using, for example, RPCs, automatic result reporting, and automatic result checking, as described above.

Likewise, in one embodiment, the combined virtual computing system 304 may include the central computing system 310 and the plurality of satellite computing systems 120 and 120a, and interact with user 330. In one embodiment, the central computing system 310 may include a central job processor 314, central data storage 312, work flow 319, job list 318, and schedule manager 316 analogous to the counterparts in the central computing system 110 discussed above. It is noted that in various embodiments, computing systems may be included in multiple virtual computing systems.

To continue the above illustrative non-limiting embodiment dealing with financial reporting, the combined virtual computing system 302 may act as a system performing the period end closing financial reports. Essentially simultaneously, a second virtual computing system 304 may be performing customer relationship management analysis. Both virtual computing systems 302 and 304 may be accessing data stored in the plurality of satellite computing systems 120 and 120a, and using the satellite computing systems 120 and 120a to perform various jobs from the respective workflows 119 and 319.

FIG. 4 is a flow chart of an embodiment of a workflow 400 in accordance with the disclosed subject matter. In one embodiment, a plurality of jobs may include Job A 402, Job B 404, Job C 406, Job D 408, Job E 410, Job F 412, Job G 414, and Job H 416. These jobs may be presented in a rudimentary fashion (e.g., a spreadsheet, a text file, etc.), or in a more sophisticated user interface associated with a workflow system (e.g., workflow engine or workflow design editor). A basic job list may include, in one embodiment, basic dependencies and the location of the satellite computing system responsible for each job. In various embodiments, the schedule manager or other entity may take the rudimentary job list and convert it into a workflow, such illustrated by FIG. 4. Such a workflow 400 may organize the jobs into a structure that represents the order the jobs may be performed in. Such a structure may include an indication of which jobs may be performed in serial, which jobs may be performed in parallel, the dependencies between the jobs, the order the jobs may be performed, etc.; although, it is understood that the above are merely a few illustrative examples to which the disclosed subject matter is not limited.

Block 450 illustrates that, in one embodiment, the Job D 408 may fail or return an unacceptable result. As such, steps may be taken to ameliorate this failure. In various embodiments, the central computing system or the schedule manager may restart the job, inform a user of the failure, continue to process other jobs that are not dependent upon the results of the failed job (e.g., Job E 410 and Job F 412), stall or skip jobs that are dependent upon the results of the failed job (e.g., Job G 414 and Job H 416), etc.; although, it is understood that the above are merely a few illustrative examples to which the disclosed subject matter is not limited.

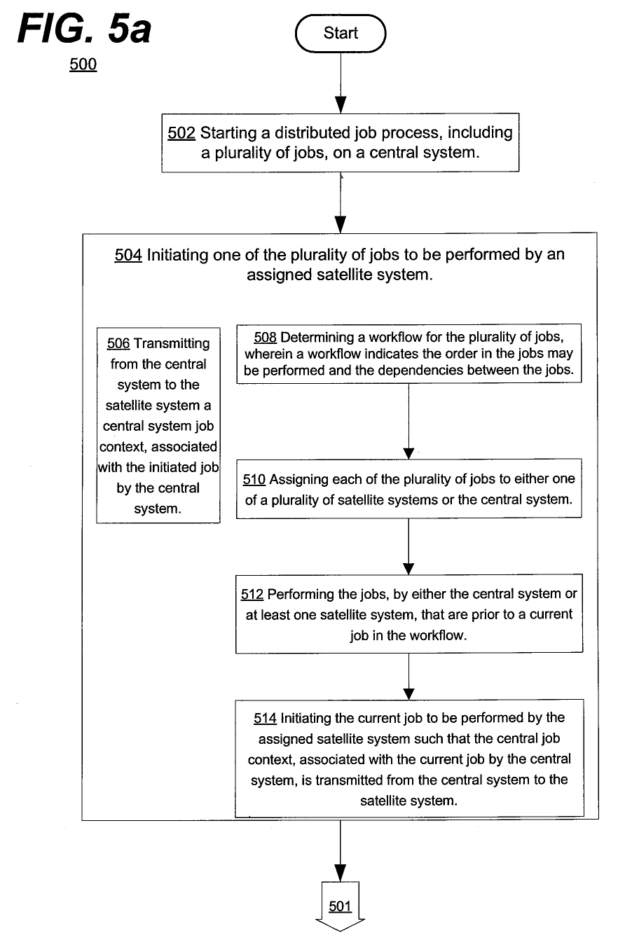

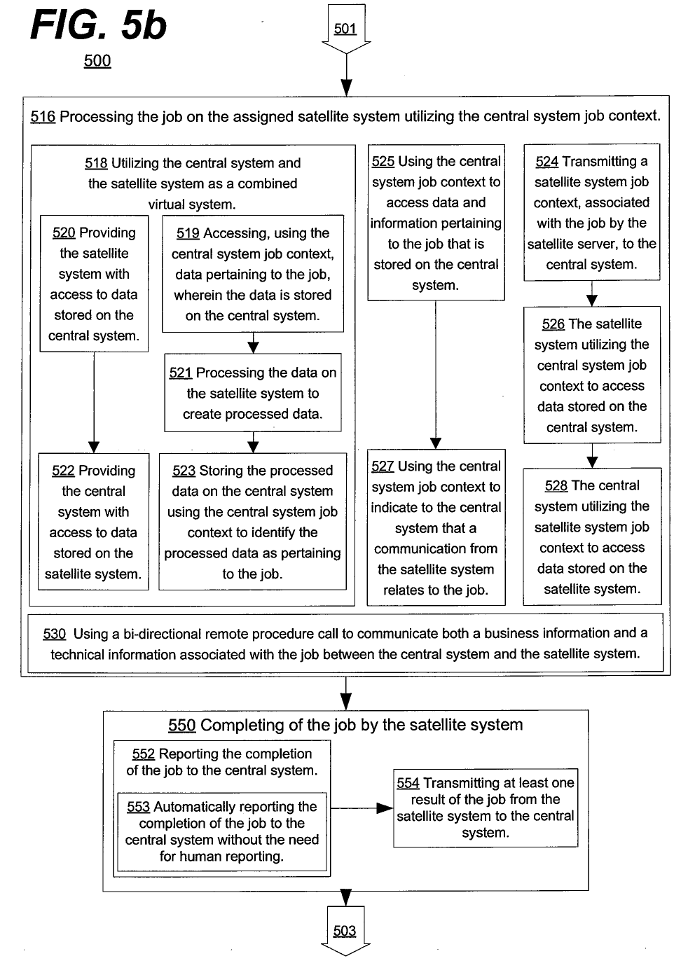

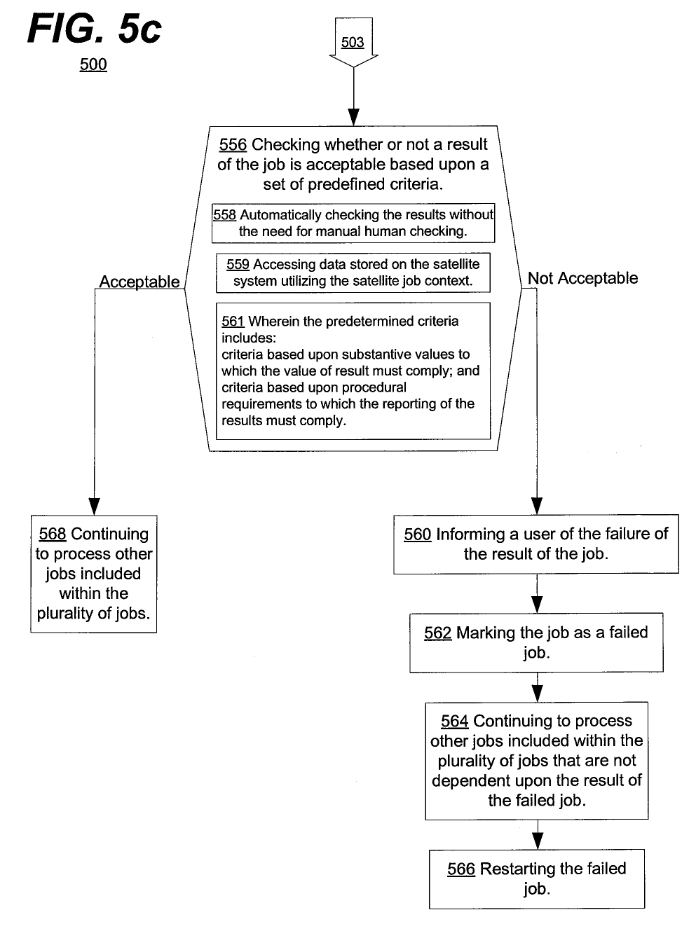

FIG. 5 is a flow chart of an embodiment of a technique in accordance with the disclosed subject matter. It is understood that FIGS. 5a, 5b, and 5c represent a single flowchart illustrated on three pages. The connectors 501 and 503 provide a way to represent the connection between the pages. Herein, the flowchart of the technique 500 is simply referred to as FIG. 5, as if the flowchart occupied a single page.

Block 502 illustrates that, in one embodiment, a distributed job process, including a plurality of jobs, may be started on a central computing system. In various embodiments, the distributed job process may be started by a user. In some embodiments, the central computing system 110 or the schedule manager 116 of FIG. I may start the distributed job process, as described above.

Block 504 illustrates that, in one embodiment, one of the plurality of jobs may be initiated so that the job is to be performed by at least one satellite system. It is understood, that in various embodiments a portion of the plurality of jobs may be performed by the central computing system and a second portion performed by various satellite computing systems. In some embodiments, the central computing system 110 or the schedule manager 116 of FIG. I may initiate the assigned job, as described above.

Block 506 illustrates that, in one embodiment, a central system job context, associated with the initiated job by the central system, may be transmitted from the central system to the satellite system. In some embodiments, the central computing system 110 or the schedule manager 116 of FIG. 1 may transmit the central job context, as described above.

Block 508 illustrates that, in one embodiment, initiating one of the plurality of jobs on a satellite computing system may include determining a workflow for the plurality of jobs, wherein a workflow indicates the order in the jobs may be performed and the dependencies, if any, between the jobs. In some embodiments, the central computing system 110 or the schedule manager 116 of FIG. I may determine the workflow, as described above.

Block 510 illustrates that, in one embodiment, initiating one of the plurality of jobs on a satellite computing system may include assigning each of the plurality of jobs to either one of a plurality of satellite systems or the central system. In various embodiments, alternative computing systems may be selected, and used if the preferred computing system becomes unavailable or less preferred (e.g., the preferred system is busy, etc.). In other embodiments, jobs may be assigned to a particular satellite computing system and may not be reassigned to another system. In such an embodiment, the other forms of amelioration may occur if issues with the preferred computing system arise. In some embodiments, the central computing system 110 or the schedule manager 116 of FIG. 1 may assign the jobs, as described above.

Block 512 illustrates that, in one embodiment, initiating one of the plurality of jobs on a satellite computing system may include performing the jobs, by either the central system or at least one satellite system that are prior to a current job in the workflow. In various embodiments, the jobs may be performed by the computing systems to which the jobs were assigned as part of Block 510. In some embodiments, the central computing system 110 or the satellite computing system 120 of FIG. 1 may perform the jobs, as described above.

Block 514 illustrates that, in one embodiment, initiating one of the plurality of jobs on a satellite computing system may include initiating the current job to be performed by the assigned satellite system. In further embodiments, the central job context, associated with the current job by the central system, may be transmitted from the central system to the satellite system. In some embodiments, the central computing system 110 or the schedule manager 116 of FIG. 1 may initiate the current job and transmit the central job context, as described above.

Block 516 illustrates that, in one embodiment, each job may be processed on the respective assigned satellite system or central system. In various embodiments, the job may be processed satellite computing system utilizing the central system job context. In some embodiments, the satellite computing system 120 or the satellite job processor 124 of FIG. 1 may process the job, as described above.

Block 518 illustrates that, in one embodiment, processing the assigned job may include utilizing the central system and the satellite system as a combined virtual system. In some embodiments, the satellite computing system 120 and the central computing system 110 of FIG. 1, or the combined virtual computing system 302 of FIG. 3 may act as a combined virtual system, as described above.

Block 520 illustrates that, in one embodiment, utilizing the central system and the satellite system as a combined virtual system may include providing the satellite system with access to data stored on the central system. In some embodiments, the central job context 113 of FIG. 1 may provide access to data stored on the central computing system, as described above.

Block 522 illustrates that, in one embodiment, utilizing the central system and the satellite system as a combined virtual system may include providing the central system with access to data stored on the satellite system. In some embodiments, the satellite job context 123 of FIG. 1 may provide access to data stored on the central computing system, as described above.

Block 519 illustrates that, in one embodiment, utilizing the central system and the satellite system as a combined virtual system may include accessing, using the central system job context, data pertaining to the job, wherein the data is stored on the central system. In some embodiments, the satellite computing system 120 of FIG. 1 may access the data stored on the central computing system, as described above.

Block 521 illustrates that, in one embodiment, utilizing the central system and the satellite system as a combined virtual system may include processing the data on the satellite system to create processed data. In some embodiments, the satellite job processor 124 of FIG. 1 may process the data, as described above.

Block 523 illustrates that, in one embodiment, utilizing the central system and the satellite system as a combined virtual system may include storing the processed data on the central system using the central system job context to identify the processed data as pertaining to the job. In some embodiments, the satellite job processor 124 of FIG. 1 may store the data, as described above.

Block 525 illustrates that, in one embodiment, processing the job may include using the central system job context to access data and information pertaining to the job that is stored on the central system. In some embodiments, the satellite computing system 120 of FIG. 1 may access the data stored on the central system, as described above.

Block 527 illustrates that, in one embodiment, processing the job may include using the central system job context to indicate to the central system that a communication from the satellite system relates to the job. In some embodiments, the satellite computing system 120 of FIG. 1 may communicate with the central system, as described above.

Block 524 illustrates that, in one embodiment, processing the assigned job may include transmitting a satellite system job context, associated with the job by the satellite server, to the central system. In some embodiments, the satellite computing system 120 or the satellite job processor 124 of FIG. 1 may transmit the satellite job context, as described above.

Block 526 illustrates that, in one embodiment, processing the assigned job may include the satellite system utilizing the central system job context to access data stored on the central system. In some embodiments, the satellite computing system 120 or the satellite job processor 124 of FIG. 1 may access the data, as described above.

Block 528 illustrates that, in one embodiment, processing the assigned job may include the central system utilizing the satellite system job context to access data stored on the satellite system. In some embodiments, the central computing system 110 or the central job processor 114 of FIG. 1 may access the data, as described above.

Block 530 illustrates that, in one embodiment, processing the assigned job may include using a bi-directional remote procedure call to communicate both business information and technical information associated with the job between the central system and the satellite system. Various illustrative non-limiting examples of business and technical information are described above. In various embodiments, the bi-directional remote procedure call(s) (RPC) may be used to perform other steps of technique 500. In some embodiments, the central computing system 110, the central job processor 114, the satellite computing system 120, or the satellite job processor 124 of FIG. 1 may make use of the bi-directional RPCs, as described above.

Block 550 illustrates that, in one embodiment, the assigned job may be completed by the satellite system. In some embodiments, the satellite computing system 120 or the satellite job processor 124 of FIG. 1 may complete the assigned job, as described above.

Block 552 illustrates that, in one embodiment, completing the job may include reporting the completion of the job to the central system. In some embodiments, the satellite computing system 120 or the satellite job processor 124 of FIG. I may report the completion of the assigned job, as described above.

Block 553 illustrates that, in one embodiment, reporting the completion may include automatically reporting the completion of the job to the central system without the need for human reporting. In various embodiments, this may be contrasted with embodiments in which a user or human at the satellite computing system must report back to another user or human at the central computing system that the assigned job has been completed. In some embodiments, the satellite computing system 120 or the satellite job processor 124 of FIG. 1 may report the completion of the assigned job, as described above.

Block 554 illustrates that, in one embodiment, completing the job may include transmitting at least one result of the job from the satellite system to the central system. In various embodiments, the central system may utilize the satellite system job context to access or request the results of the completed job. In some embodiments, the satellite computing system 120 or the satellite job processor 124 of FIG. 1 may transmit the result, as described above.

Block 556 illustrates that, in one embodiment, the result (or a portion thereof) of the job may be checked to determine whether or not the result is acceptable. Various illustrative non-limiting examples of acceptability are described above. In some embodiments, the central computing system 110 or the schedule manager 116 of FIG. 1 may check the result, as described above.

Block 558 illustrates that, in one embodiment, checking the result may include automatically checking the results without the need for manual human checking. In various embodiments, this may be contrasted with embodiments in which a user or human at either the central or satellite computing systems must manually check that the assigned job has been successfully completed. In other embodiments, this may be contrasted with embodiments in which only the programmatic or technical aspects of the assigned job have successfully been completed, not whether or not the results of the job are acceptable or any good. In some embodiments, the central computing system 110 or the schedule manager 116 of FIG. 1 may check the result, as described above.

Block 559 illustrates that, in one embodiment, checking the result may include accessing data stored on the satellite system, utilizing the satellite job context. In some embodiments, the central computing system 110 or the schedule manager 116 of FIG. 1 may access the data, as described above.

Block 561 illustrates that, in one embodiment, checking may include the use of predetermined criteria comprising criteria based upon substantive values to which the value of result must comply; and criteria based upon procedural requirements to which the reporting of the results must comply, as described above. In some embodiments, the central computing system 110 or the schedule manager 116 of FIG. 1 may check the result, as described above.

Block 568 illustrates that, in one embodiment, if the results are acceptable, processing of the other jobs included within the plurality of jobs may continue. In various embodiments, the processing of these jobs may occur as described in Blocks 504, 516, 550, and 556 of technique 500. In some embodiments, the central computing system 110 and/or the satellite computing system 120 of FIG. 1 may process the jobs, as described above.

Block 560 illustrates that, in one embodiment, if the results are not acceptable, a user may be informed of the failure of the result of the job. Block 562 illustrates that, in one embodiment, if the results are not acceptable, the job may be marked as a failed job. Block 564 illustrates that, in one embodiment, if the results are not acceptable, the processing of other jobs included within the plurality of jobs that are not dependent upon the result of the failed job may continue. Block 566 illustrates that, in one embodiment, if the results are not acceptable, the failed job may be restarted. In various embodiments, some of these, all of these, and/or other ameliorative actions may be taken in response to a failed or unacceptable result from the completed job. In some embodiments, the central computing system 110 or the schedule manager 116 of FIG. 1 may attempt to take ameliorative action, as described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A method of performing a business reporting job process comprising:
starting, on a central system, a distributed job process, including a plurality of jobs;
initiating one of the plurality of jobs to be performed by at least one assigned satellite system, including transmitting a central system job context, associated with the initiated job by the central system, from the central system to the satellite system;
processing the job on the assigned satellite system utilizing the central system job context;
upon a completion of the job by the satellite system:
reporting the completion of the job to the central system, and
transmitting at least one result of the job from the satellite system to the central system; and
checking whether or not the result of the job is acceptable, based upon a set of predetermined criteria.

2. The method of claim 1 wherein processing a job on a satellite system includes:
using a bidirectional remote procedure call to communicate both business information and technical information associated with the job between the central system and the satellite system.

3. The method of claim 1 wherein processing a job includes:
utilizing the central system and the satellite system as a combined virtual system.

4. The method of claim 3 wherein processing the job includes:
accessing, using the central system job context, data pertaining to the job, wherein the data is stored on the central system;
processing the data on the satellite system to create processed data; and
storing the processed data on the central system using the central system job context to identify the processed data as pertaining to the job.

5. The method of claim 1 wherein processing a job on the satellite system includes transmitting a satellite system job context, associated with the job by the satellite server, to the central system.

6. The method of claim 1 wherein the central system job context includes an identifier that allows the satellite system when processing the job to:
access data and information pertaining to the job that is stored on the central system, and
indicate to the central system that a communication from the satellite system relates to the job.

7. The method of claim 1 wherein reporting the completion of the job to the central system includes automatically reporting the completion of the job to the central system without the need for manual human reporting; and
wherein checking whether or not the result of the job is acceptable includes automatically checking without the need for manual human checking.

8. The method of claim 1 wherein initiating one of the plurality of jobs includes:
determining a workflow for the plurality of jobs, wherein a workflow indicates the order in which jobs may be performed and the dependencies between the jobs;
assigning each of the plurality of jobs to either a satellite system or the central system;
performing jobs, by either the central system or at least one satellite system, that are prior to a current job in the workflow; and
initiating the current job to be performed by the assigned satellite system such that the central system job context, associated with the current job by the central system, is transmitted from the central system to the satellite system.

9. The method of claim 1 wherein the predetermined criteria includes:
criteria based upon substantive values to which the value of result must comply; and
criteria based upon procedural requirements to which the reporting of the results must comply.

10. A system comprising:
a central computing system, comprising:
a central data storage configured to store data associated with a job, wherein access to the data may be facilitated by a central job context associated with the job,
a schedule manager configured to:
manage a distributed job process including a plurality of jobs,
initiate one of the plurality of jobs to be performed by at least one satellite computing system, including transmitting the central job context from the central system to the satellite system; and
plurality of satellite computing systems, each comprising:
a satellite data storage configured to store data, wherein access to the data may be facilitated by a satellite job context associated with the job,
a satellite job processor configured to:
process a job initiated by the central computing system,
report the completion of the job to the central computing system, and
transmit at least one result of the job from the satellite computing system to the central computing system for checking.

11. The system of claim 10 wherein the central computing system further comprises:
a central job processor configured to process at least one of the plurality of jobs.

12. The system of claim 10 wherein the satellite job processor is configured to interact with the central computing system using a bidirectional remote procedure call to communicate both business information and technical information.

13. The system of claim 10 wherein the satellite job processor configured to:
access the central data storage, using the central job context; and
use at least a portion of the data stored within the central data storage to process the job initiated by the central computing system.

14. The system of claim 10 wherein the satellite job processor is configured to:
provide the satellite job context to the central computing system; and
wherein the schedule manager is configured to:
access the satellite data storage, using the satellite job context; and
use data stored within the satellite data storage to manage a decentralized job process including a plurality of jobs.

15. The system of claim 10 wherein the schedule manager is configured to check whether or not the result from the satellite computing system is acceptable.

16. The system of claim 10 wherein the satellite job processor is configured to:
automatically report the completion of the job to the central computing system in such a way that no manual human reporting is required, and
automatically transmit at least a portion of the result of the job to the central computing system; and
wherein the schedule manager is configured to automatically check whether or not the result of the job is acceptable in such a way that no manual human checking is required.

17. The system of claim 11 wherein the schedule manager is configured to:
facilitate communication amongst the plurality of satellite computing systems; and
wherein each satellite job processor is configured to:
communicate, as requested, both business information and technical information to the schedule manager, the central job processor, or other satellite job processors of the plurality of satellite computing systems.

18. The system of claim 10 wherein the distributed job process includes a business reporting job process.

19. A machine readable medium comprising instructions capable of being executed by at least one machine, which, when executed, cause the machine to:
start, on a central system, a distributed job process, including a plurality of jobs;
assign one of the plurality of jobs to a satellite system;
initiate the job to be performed by the assigned satellite system, including transmitting a central system job context, associated with the initiated job by the central system, from the central system to the satellite system;
process the job by the assigned satellite system utilizing the central system job context;
upon a completion of the job by the satellite system:
report the completion of the job to the central system, and
transmit at least one result of the job from the satellite system to the central system; and
check whether or not the result of the job is acceptable based upon a set of predetermined criteria.

20. The machine readable medium of claim 19 wherein the instructions providing for reporting the completion of the job to the central system include automatically reporting the completion of the job to the central system without the need for manual human reporting; and
wherein the instructions providing for checking whether or not the result of the job is acceptable include instructions for automatically checking without the need for manual human checking.
